(19) United States
(12) Patent Application Publication
(10) Pub. No.: US 2026/0212855 A1
(43) Pub. Date: Jul. 23, 2026

(54) POROUS OBJECT MANUFACTURING WITH ACOUSTIC LEVITATION

(71) Applicant: INTERNATIONAL BUSINESS MACHINES CORPORATION, ARMONK, NY (US)

(72) Inventors: Sarbajit Kumar Rakshit, Kolkata (IN); Apparsamy Perumal, Bangalore (IN); Sathya Santhar, Ramapuram (IN); Sridevi Kannan, Katupakkam, Chennai (IN)

(21) Appl. No.: 19/034,904

(22) Filed: Jan. 23, 2025

(51) Int. Cl. G10K 15/00; B22F 10/34; B22F 10/38; B22F 10/85; B29C 64/153; B29C 64/393; B29K 105/04; B33Y 10/00; B33Y 50/02

(52) U.S. Cl. CPC G10K 15/00; B22F 10/34; B22F 10/38; B22F 10/85; B29C 64/153; B29C 64/393; B33Y 10/00; B33Y 50/02; B22F 2202/01; B29K 2105/04

(57) ABSTRACT

An embodiment for porous object manufacturing with acoustic levitation of powder particles is provided. The embodiment may include receiving real-time and historical data from one or more sources in a 3D printing environment. The embodiment may also include identifying one or more characteristics of a plurality of powder particles. The embodiment may further include identifying a pre-determined level of porosity of an object to be assembled with at least a portion of the plurality of powder particles. The embodiment may also include computing one or more parameters for a plurality of hardware devices. The embodiment may further include causing at least one hardware device of the plurality of hardware devices to create a floating arrangement of the portion of the plurality of powder particles consistent with the computed one or more parameters.

### BACKGROUND

The present invention relates generally to the field of computing, and more particularly to a system for porous object manufacturing with acoustic levitation of powder particles.

Powder fusion is a cutting-edge additive manufacturing technique that revolutionizes the way intricate 3D objects are created. This technique involves the meticulous layer-by-layer fusion of fine powder particles, typically metals or polymers, to form solid structures. Powder fusion begins with an even distribution of a thin layer of powder over a build platform. Subsequently, the selective fusion of these powder particles occurs, which may be achieved through Selective Laser Melting (SLM), Electron-Beam Melting (EBM), or Binder Jetting. Layer-by-layer, the powder bed is built up, cooled, and solidified, ultimately producing an optimal 3D product.

### SUMMARY

According to one embodiment, a method, computer system, and computer program product for porous object manufacturing with acoustic levitation of powder particles is provided. The method, computer system, and computer program product may include receiving real-time and historical data from one or more sources in a 3D printing environment. The method, computer system, and computer program product may also include identifying one or more characteristics of a plurality of powder particles based on the real-time and the historical data. The method, computer system, and computer program product may further include identifying a pre-determined level of porosity of an object to be assembled with at least a portion of the plurality of powder particles. The method, computer system, and computer program product may also include computing one or more parameters for a plurality of hardware devices based on the pre-determined level of porosity and the one or more characteristics. The method, computer system, and computer program product may further include causing at least one hardware device of the plurality of hardware devices to create a floating arrangement of the portion of the plurality of powder particles consistent with the computed one or more parameters.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIG. 2 illustrates an operational flowchart for porous object manufacturing with acoustic levitation of powder particles in an acoustic levitation process according to at least one embodiment.

FIG. 3 is an exemplary diagram depicting the controlled arrangement of powder particles using acoustic levitation according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for porous object manufacturing with acoustic levitation of powder particles. The following described exemplary embodiments provide a system, method, and program product to, among other things, cause at least one hardware device to create a floating arrangement of a portion of a plurality of powder particles in accordance with computed one or more parameters and, accordingly, cause at least one other hardware device to fuse the portion of the plurality of powder particles in the floating arrangement to an object being assembled. Therefore, the present embodiment has the capacity to improve 3D printing technology by maintaining a pre-determined level of porosity in building an object with powder particles.

As previously described, powder fusion is a cutting-edge additive manufacturing technique that revolutionizes the way intricate 3D objects are created. This technique involves the meticulous layer-by-layer fusion of fine powder particles, typically metals or polymers, to form solid structures. Powder fusion begins with an even distribution of a thin layer of powder over a build platform. Subsequently, the selective fusion of these powder particles occurs, which may be achieved through Selective Laser Melting (SLM), Electron-Beam Melting (EBM), or Binder Jetting. Layer-by-layer, the powder bed is built up, cooled, and solidified, ultimately producing an optimal 3D product. Currently, there is no process to support the selected porousness of an object to be assembled. This problem is typically addressed by creating a pressure differential to levitate powder particles. However, merely creating a pressure differential fails to consider the selective level of porosity of the object.

It may therefore be imperative to have a system in place to form a 3D printed object with the selected level of porousness.

According to at least one embodiment, a computer-based method, computer system, and computer program product for porous object manufacturing with acoustic levitation of powder particles is provided. The method comprises receiving real-time and historical data from one or more sources in a 3D printing environment, identifying one or more characteristics of a plurality of powder particles based on the real-time and the historical data, identifying a pre-determined level of porosity of an object to be assembled with at least a portion of the plurality of powder particles, computing one or more parameters for a plurality of hardware devices based on the pre-determined level of porosity and the one or more characteristics, and causing at least one hardware device of the plurality of hardware devices to create a floating arrangement of the portion of the plurality of powder particles consistent with the computed one or more parameters. This embodiment has the advantage of maintaining a selected level of porousness of an object during a powder fusion process.

According to at least one embodiment, the method may further comprise determining whether a current floating arrangement produces the pre-determined level of porosity, and based on determining the current floating arrangement produces the pre-determined level of porosity, causing at least one other hardware device of the plurality of hardware devices to fuse the portion of the plurality of powder particles in the current floating arrangement to the object. This embodiment has the advantage of verifying the floating arrangement of powder particles prior to fusion with the object.

According to at least one embodiment, the method may further comprise based on determining the current floating arrangement does not produce the pre-determined level of porosity, iterating, until the current floating arrangement produces the pre-determined level of porosity, computing one or more modified parameters for the plurality of hardware devices based on the pre-determined level of porosity and the one or more characteristics, and causing the at least one hardware device to create a modified floating arrangement of the portion of the plurality of powder particles consistent with the computed one or more modified parameters. The method may further comprise causing the at least one other hardware device to fuse the portion of the plurality of powder particles in the modified current floating arrangement to the object. This embodiment has the advantage of proactively correcting any errors in the floating arrangement of the powder particles that could cause a defect in the object.

According to at least one embodiment, determining whether the current floating arrangement produces the pre-determined level of porosity may further comprise receiving captured images of the current floating arrangement of the portion of the plurality of powder particles and the object from one or more Internet of Things (IoT) devices, computing a spacing between the portion of the plurality of powder particles based on the captured images, and comparing the spacing between the portion of the plurality of powder particles with the pre-determined level of porosity of the object. This embodiment has the advantage of verifying the floating arrangement of powder particles captured by IoT devices.

According to at least one embodiment, the method may further comprise adjusting a magnitude and a direction of levitation force generated by the at least one hardware device based on determining at least one characteristic of the one or more characteristics changes. This embodiment has the advantage of dynamically adapting hardware device parameters based on changes in the powder particles.

According to at least one embodiment, causing the at least one hardware device to create the floating arrangement of the portion of the plurality of powder particles may further comprise computing a thickness of the portion of the plurality of powder particles in the current floating arrangement to produce the pre-determined level of porosity of the object based on the one or more characteristics of the plurality of powder particles, and selecting a magnitude and a direction of levitation force generated by the at least one hardware device to achieve the computed thickness. This embodiment has the advantage of enhancing precision in powder fusion 3D printing processes.

According to at least one embodiment, the at least one hardware device may include one or more ultrasonic transducers, and the at least one other hardware device may include one or more lasers configured to generate a laser beam. This embodiment has the advantage of optimizing powder fusion 3D printing processes utilizing specific hardware.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to cause at least one hardware device to create a floating arrangement of a portion of a plurality of powder particles in accordance with computed one or more parameters and, accordingly, cause at least one other hardware device to fuse the portion of the plurality of powder particles in the floating arrangement to an object being assembled.

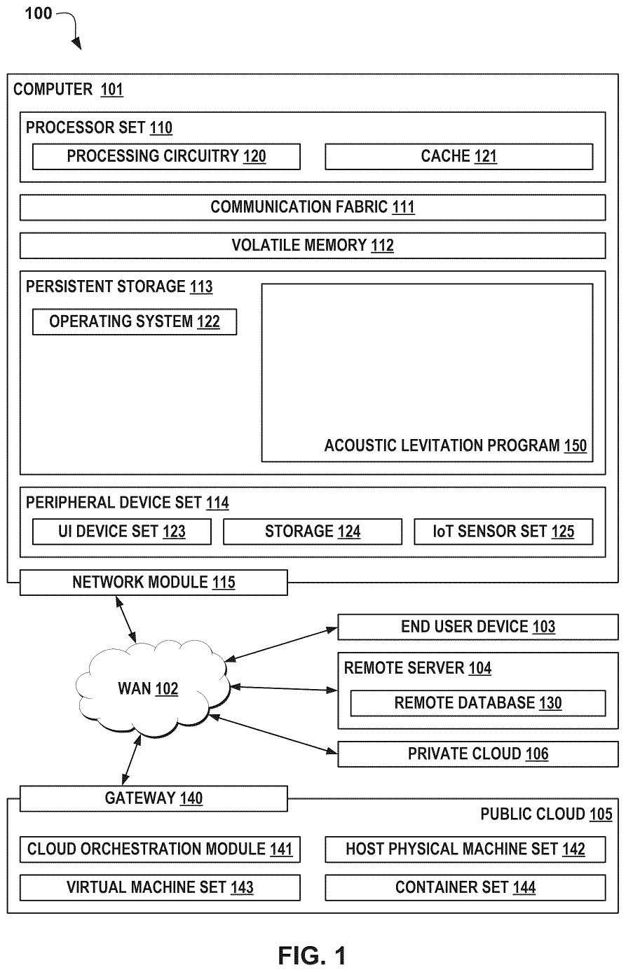

Referring to FIG. 1, an exemplary computing environment 100 is depicted, according to at least one embodiment. Computing environment 100 contains an example of an environment for the execution of at least some of the computer code involved in performing the inventive methods, such as an acoustic levitation program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. Peripheral device set 114 may also include, but is not limited to, a 3D printer, cameras, sensors, lasers, and/or acoustic levitation devices.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

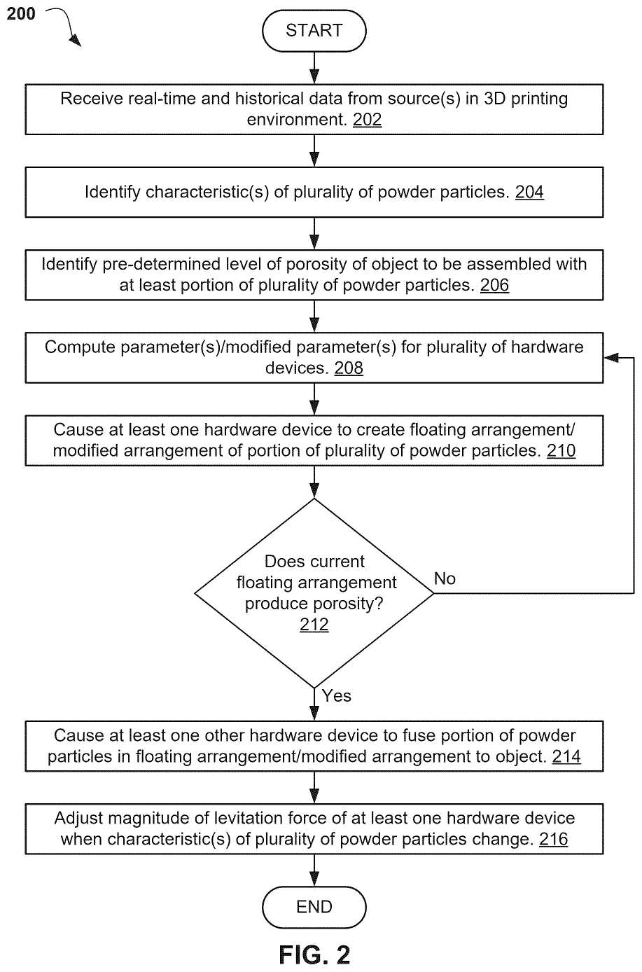

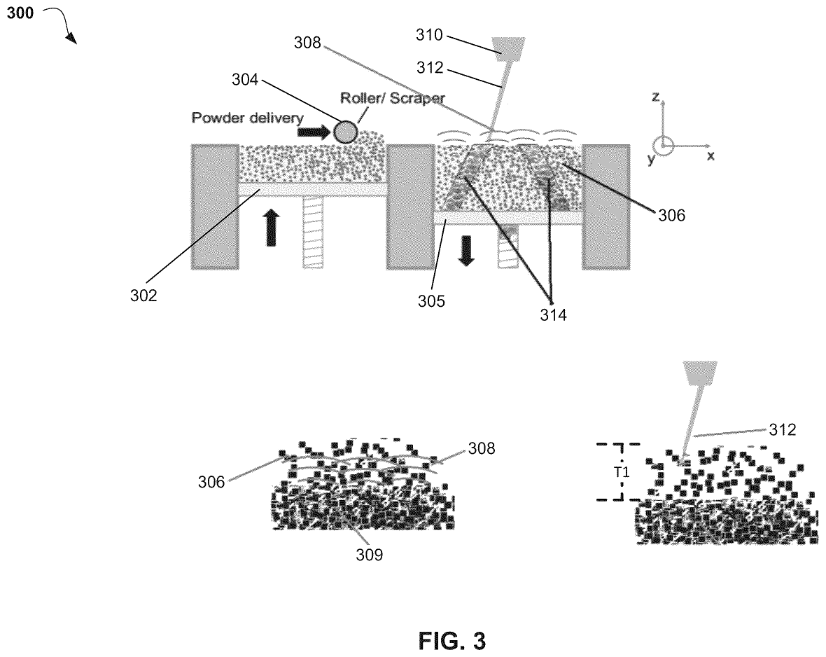

According to the present embodiment, the acoustic levitation program 150 may be a program capable of receiving real-time and historical data from one or more sources in a 3D printing environment, causing at least one hardware device to create a floating arrangement of a portion of a plurality of powder particles in accordance with computed one or more parameters, and causing at least one other hardware device to fuse the portion of the plurality of powder particles in the floating arrangement to an object being assembled. Furthermore, notwithstanding depiction in computer 101, the acoustic levitation program 150 may be stored in and/or executed by, individually or in any combination, end user device 103, remote server 104, public cloud 105, and private cloud 106. The acoustic levitation method is explained in further detail below with respect to FIGS. 2 and 3. It may be appreciated that the examples described below are not intended to be limiting, and that in embodiments of the present invention the parameters used in the examples may be different.

Referring now to FIG. 2, an operational flowchart for porous object manufacturing with acoustic levitation of powder particles in an acoustic levitation process 200 is depicted according to at least one embodiment. At 202, the acoustic levitation program 150 receives the real-time and historical data from the one or more sources in the 3D printing environment. The one or more sources may include, but are not limited to, a camera, sensors, and/or the build platform.

The one or more sources may be utilized by the acoustic levitation program 150 to capture characteristics of the plurality of powder particles. The one or more characteristics may include, but are not limited to, specifications of the plurality of powder particles (e.g., dimensions such as length, width, and/or height), and/or particle properties (e.g., particle type, melting point, and/or malleability). The data may also include, but is not limited to, available laser beam energy, powder layer thickness, and the object to be assembled by 3D printing. For example, a sensor on the build platform may be used to detect the weight of the plurality of powder particles. In another example, the camera may be used to detect the weight and height of the powder particles as well as the powder layer thickness. As described above, the data is collected in real-time and historically. The historical data may be input into and retrieved from a knowledge corpus and/or database, such as remote database 130. In this manner, the real-time data becomes the historical data upon being input into the knowledge corpus and/or remote database 130.

Then, at 204, the acoustic levitation program 150 identifies the one or more characteristics of the plurality of powder particles. The one or more characteristics are identified based on the real-time and the historical data. As described above with respect to step 202, the one or more characteristics may include, but are not limited to, specifications of the plurality of powder particles (e.g., dimensions such as length, width, and/or height), and/or particle properties (e.g., particle type, melting point and/or malleability).

For example, each powder particle on the build platform may weigh two ounces, and be 0.5 centimeters in width and height. The particle type may be metals, the melting point may be 660° C., and the particles may be malleable. In another example, each powder particle on the build platform may weigh one ounce, and be 0.8 centimeters in width and height. The particle type may be polymers, the melting point may be 200° C., and the particles may be non-malleable.

According to at least one embodiment, the one or more characteristics of the plurality of powder particles may be identified in real-time on the build platform. For example, the camera may be used to determine the dimensions of the plurality of powder particles and the sensor may be used to determine the weight of the plurality of powder particles. According to at least one other embodiment, the one or more characteristics of the plurality of powder particles may be identified at least partially based on the historical data. When the type of object to be assembled is known, some of the one or more characteristics may be obtained from the historical data in the database, such as remote database 130. For example, during a past 3D printing process, where the object being assembled is a showerhead, the acoustic levitation program 150 may infer the same characteristics may be applied to the plurality of powder particles being used to assemble the showerhead in the present.

Next, at 206, the acoustic levitation program 150 identifies the pre-determined level of porosity of the object to be assembled with at least the portion of the plurality of powder particles. According to at least one embodiment, all of the powder particles may be used to assemble the object. According to at least one other embodiment, some of the powder particles may not be used to assemble the object (e.g., due to a lack of force at certain areas of the build platform). Therefore, the term “portion of the plurality of powder particles” should be construed to include situations where all of the powder particles are used and situations where some but not all of the powder particles are used.

The pre-determined level of porosity may include the size of holes in the object. For example, on an oscillating sprinkler, the holes may be one centimeter in diameter. The pre-determined level of porosity may also include a spacing between the holes in the object. For example, on the oscillating sprinkler, the holes may be 2 centimeters apart. The pre-determined level of porosity may be input by a user (e.g., a supervisor in the 3D printing environment). Alternatively, the pre-determined level of porosity may be obtained from the historical data. For example, where the oscillating sprinkler assembled in the past had holes 2 centimeters apart and were one centimeter in diameter, the pre-determined level of porosity of the oscillating sprinkler being assembled in the present may also be holes 2 centimeters apart and one centimeter in diameter.

Then, at 208, the acoustic levitation program 150 computes the one or more parameters for the plurality of hardware devices. The one or more parameters are computed based on the pre-determined level of porosity and the one or more characteristics. The plurality of hardware devices may include the at least one hardware device and the at least one other hardware device. The at least one hardware device may include one or more ultrasonic transducers, speakers, and/or an electrostatic generator, whereas the at least one other hardware device may include one or more lasers configured to generate a laser beam. The plurality of hardware devices are described in further detail below with respect to steps 210 and 214.

According to at least one embodiment, a machine learning model may be used to compute the one or more parameters. In addition to the historical data described above with respect to step 202, the historical data may include information about available laser energy levels and the relationship between laser energy and fusion quality. The historical data may also include information about the relationship between thickness of the powder particle layer (e.g., a vertical height of the portion of powder particles in the air) and porosity. The machine learning model may be fed this historical data as input. The machine learning model may then be trained to predict the one or more parameters for the plurality of hardware devices.

For example, the historical data may indicate that during the powder fusion assembly of the showerhead, a laser beam of 100 Watts or greater resulted in powder particle fusion (and, thus, did result in the pre-determined level of porosity), whereas a laser beam of less than 100 Watts did not result in powder particle fusion (and, thus, did not result in the pre-determined level of porosity). In this example, the computed parameter for the laser may be at least 100 Watts.

Additionally, the historical data may indicate a thickness of the powder particle layer greater than or equal to 20 centimeters resulted in the pre-determined level of porosity, whereas a thickness of the powder particle layer less that 20 centimeters did not result in the pre-determined level of porosity. To achieve the desired thickness, the machine learning model may take into account the one or more characteristics of the plurality of powder particles. The levitation force generated by the at least one hardware device may be directly proportional to the dimensions of the plurality of powder particles. For example, where a first plurality of powder particles weighs 16 ounces and a second plurality of powder particles weighs 32 ounces, more force would have to be applied to the second plurality of powder particles to achieve the desired thickness. Continuing the example, 10 Newtons may be applied to the first plurality of powder particles and 20 Newtons may be applied to the second plurality of powder particles. In another example, where the first plurality of powder particles are 0.8 centimeters in diameter and a second plurality of powder particles are 1.5 centimeters in diameter, more force would have to be applied to the second plurality of powder particles to achieve the desired thickness. Continuing the example, 10 Newtons may be applied to the first plurality of powder particles and 20 Newtons may be applied to the second plurality of powder particles.

Next, at 210, the acoustic levitation program 150 causes the at least one hardware device of the plurality of hardware devices to create the floating arrangement of the portion of the plurality of powder particles. The acoustic levitation program 150 may transmit a signal to the at least one hardware device to create the floating arrangement. The floating arrangement is created to be consistent with the computed one or more parameters. As described above with respect to step 208, the at least one hardware device may include one or more ultrasonic transducers, speakers, and/or an electrostatic generator. As used herein, “floating arrangement” means those powder particles suspended in the air and not those powder particles resting on the powder bed.

According to at least one embodiment, the at least one hardware device creates the floating arrangement via ultrasound levitation force. The at least one hardware device may be embedded in the build platform and/or a chamber surrounding the powder particles. For example, the one or more ultrasonic transducers or speakers capable of emitting high-frequency sound waves may be embedded in the build platform and/or the chamber. The sound waves may create pressure nodes and antinodes within the powder bed. The pressure variations may create a levitation effect, keeping the powder particles suspended.

According to at least one other embodiment, the at least one hardware device creates the floating arrangement via electrostatic force. The at least one hardware device may also be embedded in the build platform and/or a chamber surrounding the powder particles. For example, the electrostatic generator may apply high voltage to electrodes to create an electrostatic field. The powder particles may acquire a charge and may be repelled from or attracted to the electrodes, suspending the powder particles in mid-air. A control system may regulate the voltage and polarity of the electrodes to control levitation.

According to at least one further embodiment, causing the at least one hardware device to create the floating arrangement of the portion of the powder particles may include computing the thickness of the portion of the plurality of powder particles in the current arrangement to produce the pre-determined level of porosity of the object based on the one or more characteristics of the plurality of powder particles. As described above with respect to step 208, to achieve the desired thickness, the machine learning model may take into account the one or more characteristics of the plurality of powder particles. For example, the computed thickness of a first plurality of powder particles weighting 16 ounces may be 20 centimeters and the computed thickness of a second plurality of powder particles weighing 32 ounces may be 25 centimeters. In another example, the computed thickness of the first plurality of powder particles being 0.8 centimeters in diameter may be 20 centimeters and the computed thickness of the second plurality of powder particles being 1.5 centimeters in diameter may be 25 centimeters.

Once the thickness has been computed, the acoustic levitation program 150 may select the magnitude and the direction of the levitation force generated by the at least one hardware device to achieve the computed thickness. The magnitude and the direction of the levitation force may be consistent with the computed one or more parameters. For example, where the computed thickness of the first plurality of powder particles is 20 centimeters and the computed thickness of the second plurality of powder particles is 25 centimeters, the magnitude of the force applied to the first plurality of powder particles may be 10 Newtons and the magnitude of the force applied to the second plurality of powder particles may be 20 Newtons. The direction of the levitation force may be computed based on the shape of the object. For example, for an object having a sloped surface, the direction of the levitation force may be 45° from a horizontal axis of the build platform. In another example, for an object protruding upwards perpendicular to the build platform, the direction of the levitation force may be 90° from a horizontal axis of the build platform.

Then, at 212, the acoustic levitation program 150 determines whether the current floating arrangement produces the pre-determined level of porosity. It may be appreciated that in embodiments of the present invention, since the acoustic levitation process 200 is an iterative process, the current floating arrangement may be either a first floating arrangement or a subsequent floating arrangement. One or more IoT devices, such as a camera and/or sensors, in the 3D printing environment may monitor the current floating arrangement of the portion of the plurality of powder particles.

According to at least one embodiment, determining whether the current floating arrangement produces the pre-determined level of porosity may include receiving captured images of the current floating arrangement of the portion of the plurality of powder particles and the object from the one or more IoT devices. For example, the captured images may be of powder particles used to assemble a showerhead and/or oscillating sprinkler (e.g., porous objects) as well as the showerhead and/or oscillating sprinkler itself. The spacing between the portion of the portion of the plurality of powder particles may be computed based on the captured images. Computing the spacing may validate the computed thickness of the portion of the plurality of powder particles in the current arrangement.

Then, the spacing between the portion of the plurality of powder particles may be compared with the pre-determined level of porosity of the object. Depending on the pre-determined level of porosity of the object, the portion of the plurality of powder particles should either be loosely coupled or have visible gaps between them. As used herein, “loosely coupled” means the portion of the plurality of powder particles dangle from each other, similar to links of a chain. For example, where the holes of the object are to be farther apart from each other, the powder particles in the current floating arrangement should have gaps between them, whereas where the holes of the object are to be closer together, the powder particles in the current floating arrangement should be loosely coupled. Then, the acoustic levitation program 150 may compare the inter-particle spacing with previously fused layers of the object. The acoustic levitation program 150 may employ computer vision and/or image processing to determine whether the spacing between the portion of the plurality of powder particles in the current arrangement is consistent with the spacing of the holes on the object. The current floating arrangement may be determined to produce the pre-determined level of porosity when the spacing between the portion of the plurality of powder particles in the current arrangement is consistent with the spacing of the holes on the object.

According to at least one further embodiment, determining whether the current floating arrangement produces the pre-determined level of porosity may also include analyzing the uniformity of distribution of the portion of the plurality of powder particles. The portion of the plurality of powder particles may be uniformly distributed when the spacing between each particle is the same. For example, the portion of the plurality of powder particles may not be uniformly distributed where “Particle A” is 0.5 centimeters from “Particle B” and “Particle B” is 0.8 centimeters from “Particle C.” In this embodiment, based on determining the portion of the plurality of powder particles are not evenly distributed, the current floating arrangement may be determined to not produce the pre-determined level of porosity.

Based on determining the current floating arrangement produces the pre-determined level of porosity (step 212, “Yes” branch), the acoustic levitation process 200 proceeds to step 214 to cause the at least one other hardware device of the plurality of hardware devices to fuse the portion of the plurality of powder particles in the current floating arrangement to the object. Based on determining the current floating arrangement does not produce the pre-determined level of porosity (step 212, “No” branch), the acoustic levitation process 200 reverts to step 208 to compute the one or more modified parameters for the plurality of hardware devices.

It may be appreciated that in embodiments where the current floating arrangement does not produce the pre-determined level of porosity, steps 208 and 210 may be iterated until the current floating arrangement produces the pre-determined level of porosity. The acoustic levitation program 150 may compute the one or more modified parameters for the plurality of hardware devices based on the pre-determined level of porosity and the one or more characteristics. For example, where the 10 Newton levitation force being applied to the first plurality of powder particles and 20 Newton levitation force being applied to the second plurality of powder particles does not produce the required level of porosity, the 10 Newton levitation force may be modified to be 20 Newtons and the 20 Newton levitation force may be modified to be 30 Newtons. Then, the at least one hardware device may be caused to create the modified floating arrangement of the portion of the portion of the plurality of powder particles consistent with the computed one or more modified parameters. The modified floating arrangement may change the spacing and/or thickness of the portion of the plurality of powder particles. Continuing the example described above, the one or more ultrasonic transducers may increase the levitation force from 10 Newtons to 20 Newtons for the first plurality of powder particles and from 20 Newtons to 30 Newtons for the second plurality of powder particles. The levitation force may be gradually modified until the current floating arrangement (which may be the modified floating arrangement) produces the pre-determined level of porosity.

Next, at 214, the acoustic levitation program 150 causes the at least one other hardware device of the plurality of hardware devices to fuse the portion of the plurality of powder particles in the current floating arrangement to the object. The acoustic levitation program 150 may transmit a signal to the at least one other hardware device to fuse the portion of the plurality of powder particles to the object. As described above with respect to step 208, the at least one other hardware device may include the one or more lasers configured to generate the laser beam. The power of the laser beam may, similar to the at least one hardware device, be consistent with the computed one or more parameters. For example, where the computed parameter for the laser beam is 100 Watts, the laser may emit the laser beam at 100 Watts.

According to at least one embodiment, where the current floating arrangement is modified, the at least one other hardware device may be caused to fuse the portion of the plurality of powder particles in the modified current floating arrangement to the object. The power of the laser beam may be consistent with the modified one or more parameters. For example, the computed parameter of 100 Watts may be modified to 120 Watts. Continuing the example, the laser may emit the laser beam in accordance with the modified parameter of 120 Watts.

Then, at 216, the acoustic levitation program 150 adjusts the magnitude and the direction of the levitation force generated by the at least one hardware device. The magnitude and the direction may be adjusted based on determining at least one characteristic of the one or more characteristics changes. For example, the weight of the plurality of powder particles may change due to a different material type and/or a change in size of the powder particles being introduced to the build platform. Continuing the example, the weight of each powder particle may change from one ounce to two ounces and the diameter may change from 0.2 centimeters to 0.4 centimeters. During a time range where the change occurs, the magnitude of the levitation force may be increased or decreased to account for the change in the at least one characteristic. For example, the magnitude of the levitation force may be adjusted from 30 Newtons to 40 Newtons when the weight of each powder particle changes from one ounce to two ounces and the diameter changes from 0.2 centimeters to 0.4 centimeters. In another example, the magnitude of the levitation force may be adjusted from 40 Newtons to 30 Newtons when the weight of each powder particle changes from two ounces to one ounce and the diameter changes from 0.4 centimeters to 0.2 centimeters. It may be appreciated that in embodiments of the present invention, each hardware device applying ultrasound levitation force or electrostatic force may be operated independently.

According to at least one embodiment, the direction of the levitation force generated by the at least one hardware device may be adjusted based on the historical data. For example, the direction of the levitation force may be adjusted from 45° to 90° when the historical data indicates that 90° produced the pre-determined level of porosity in the object for the powder particles with the changed at least one characteristic.

Referring now to FIG. 3, an exemplary diagram 300 depicting the controlled arrangement of powder particles using acoustic levitation is shown according to at least one embodiment. In the diagram 300, a moving platform 302 moves upward while a roller/scraper 304 transfers the plurality of powder particles 306 onto the build platform 305. A levitation force, illustrated by arcs 308, may be exerted on the plurality of powder particles 306 to create the floating arrangement. The powder bed 309 may include one or more powder particles that are not part of the floating arrangement. The plurality of powder particles 306 in the floating arrangement may have a thickness T1, as shown in a lower portion of the diagram 300, which may produce the pre-determined level of porosity in the object 314. Additionally, the plurality of powder particles 306 in the floating arrangement may be loosely connected to each other, as shown in the lower portion of the diagram 300. The plurality of powder particles 306 having the thickness T1 may be fused to the object 314 by the laser 310 emitting the laser beam 312 in a direction of the object 314. The build platform 305 may move downward as the plurality of powder particles 306 are fused to the object 314 by the laser 310 emitting the laser beam 312. The object 314 may be assembled with the pre-determined level of porosity.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein. The present invention relates generally to the field of computing, and more particularly to a system for porous object manufacturing with acoustic levitation of powder particles.

What is claimed is:

1. A computer-based method of porous object manufacturing with acoustic levitation of powder particles, the method comprising:
receiving real-time and historical data from one or more sources in a 3D printing environment;
identifying one or more characteristics of a plurality of powder particles based on the real-time and the historical data;
identifying a pre-determined level of porosity of an object to be assembled with at least a portion of the plurality of powder particles;
computing one or more parameters for a plurality of hardware devices based on the pre-determined level of porosity and the one or more characteristics; and
causing at least one hardware device of the plurality of hardware devices to create a floating arrangement of the portion of the plurality of powder particles consistent with the computed one or more parameters.

2. The computer-based method of claim 1, further comprising:
determining whether a current floating arrangement produces the pre-determined level of porosity; and
based on determining the current floating arrangement produces the pre-determined level of porosity:
causing at least one other hardware device of the plurality of hardware devices to fuse the portion of the plurality of powder particles in the current floating arrangement to the object.

3. The computer-based method of claim 2, further comprising:
based on determining the current floating arrangement does not produce the pre-determined level of porosity, iterating, until the current floating arrangement produces the pre-determined level of porosity:
computing one or more modified parameters for the plurality of hardware devices based on the pre-determined level of porosity and the one or more characteristics; and
causing the at least one hardware device to create a modified floating arrangement of the portion of the plurality of powder particles consistent with the computed one or more modified parameters;
and
causing the at least one other hardware device to fuse the portion of the plurality of powder particles in the modified current floating arrangement to the object.

4. The computer-based method of claim 2, wherein determining whether the current floating arrangement produces the pre-determined level of porosity further comprises:
receiving captured images of the current floating arrangement of the portion of the plurality of powder particles and the object from one or more Internet of Things (IoT) devices;
computing a spacing between the portion of the plurality of powder particles based on the captured images; and
comparing the spacing between the portion of the plurality of powder particles with the pre-determined level of porosity of the object.

5. The computer-based method of claim 1, further comprising:
adjusting a magnitude and a direction of levitation force generated by the at least one hardware device based on determining at least one characteristic of the one or more characteristics changes.

6. The computer-based method of claim 1, wherein causing the at least one hardware device to create the floating arrangement of the portion of the plurality of powder particles further comprises:
computing a thickness of the portion of the plurality of powder particles in a current floating arrangement to produce the pre-determined level of porosity of the object based on the one or more characteristics of the plurality of powder particles; and
selecting a magnitude and a direction of levitation force generated by the at least one hardware device to achieve the computed thickness.

7. The computer-based method of claim 1, wherein the at least one hardware device includes one or more ultrasonic transducers, and wherein at least one other hardware device includes one or more lasers configured to generate a laser beam.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving real-time and historical data from one or more sources in a 3D printing environment;
identifying one or more characteristics of a plurality of powder particles based on the real-time and the historical data;
identifying a pre-determined level of porosity of an object to be assembled with at least a portion of the plurality of powder particles;
computing one or more parameters for a plurality of hardware devices based on the pre-determined level of porosity and the one or more characteristics; and
causing at least one hardware device of the plurality of hardware devices to create a floating arrangement of the portion of the plurality of powder particles consistent with the computed one or more parameters.

9. The computer system of claim 8, the method further comprising:
determining whether a current floating arrangement produces the pre-determined level of porosity; and
based on determining the current floating arrangement produces the pre-determined level of porosity:
causing at least one other hardware device of the plurality of hardware devices to fuse the portion of the plurality of powder particles in the current floating arrangement to the object.

10. The computer system of claim 9, the method further comprising:
based on determining the current floating arrangement does not produce the pre-determined level of porosity, iterating, until the current floating arrangement produces the pre-determined level of porosity:
computing one or more modified parameters for the plurality of hardware devices based on the pre-determined level of porosity and the one or more characteristics; and
causing the at least one hardware device to create a modified floating arrangement of the portion of the plurality of powder particles consistent with the computed one or more modified parameters;
and
causing the at least one other hardware device to fuse the portion of the plurality of powder particles in the modified current floating arrangement to the object.

11. The computer system of claim 9, wherein determining whether the current floating arrangement produces the pre-determined level of porosity further comprises:
receiving captured images of the current floating arrangement of the portion of the plurality of powder particles and the object from one or more Internet of Things (IoT) devices;
computing a spacing between the portion of the plurality of powder particles based on the captured images; and
comparing the spacing between the portion of the plurality of powder particles with the pre-determined level of porosity of the object.

12. The computer system of claim 8, the method further comprising:
adjusting a magnitude and a direction of levitation force generated by the at least one hardware device based on determining at least one characteristic of the one or more characteristics changes.

13. The computer system of claim 8, wherein causing the at least one hardware device to create the floating arrangement of the portion of the plurality of powder particles further comprises:
computing a thickness of the portion of the plurality of powder particles in a current floating arrangement to produce the pre-determined level of porosity of the object based on the one or more characteristics of the plurality of powder particles; and
selecting a magnitude and a direction of levitation force generated by the at least one hardware device to achieve the computed thickness.

14. The computer system of claim 8, wherein the at least one hardware device includes one or more ultrasonic transducers, and wherein at least one other hardware device includes one or more lasers configured to generate a laser beam.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving real-time and historical data from one or more sources in a 3D printing environment;
identifying one or more characteristics of a plurality of powder particles based on the real-time and the historical data;
identifying a pre-determined level of porosity of an object to be assembled with at least a portion of the plurality of powder particles;
computing one or more parameters for a plurality of hardware devices based on the pre-determined level of porosity and the one or more characteristics; and
causing at least one hardware device of the plurality of hardware devices to create a floating arrangement of the portion of the plurality of powder particles consistent with the computed one or more parameters.

16. The computer program product of claim 15, the method further comprising:
determining whether a current floating arrangement produces the pre-determined level of porosity; and
based on determining the current floating arrangement produces the pre-determined level of porosity:
causing at least one other hardware device of the plurality of hardware devices to fuse the portion of the plurality of powder particles in the current floating arrangement to the object.

17. The computer program product of claim 16, the method further comprising:
based on determining the current floating arrangement does not produce the pre-determined level of porosity, iterating, until the current floating arrangement produces the pre-determined level of porosity:
computing one or more modified parameters for the plurality of hardware devices based on the pre-determined level of porosity and the one or more characteristics; and
causing the at least one hardware device to create a modified floating arrangement of the portion of the plurality of powder particles consistent with the computed one or more modified parameters;
and
causing the at least one other hardware device to fuse the portion of the plurality of powder particles in the modified current floating arrangement to the object.

18. The computer program product of claim 16, wherein determining whether the current floating arrangement produces the pre-determined level of porosity further comprises:
receiving captured images of the current floating arrangement of the portion of the plurality of powder particles and the object from one or more Internet of Things (IoT) devices;
computing a spacing between the portion of the plurality of powder particles based on the captured images; and
comparing the spacing between the portion of the plurality of powder particles with the pre-determined level of porosity of the object.

19. The computer program product of claim 15, the method further comprising:
adjusting a magnitude and a direction of levitation force generated by the at least one hardware device based on determining at least one characteristic of the one or more characteristics changes.

20. The computer program product of claim 15, wherein causing the at least one hardware device to create the floating arrangement of the portion of the plurality of powder particles further comprises:
computing a thickness of the portion of the plurality of powder particles in a current floating arrangement to produce the pre-determined level of porosity of the object based on the one or more characteristics of the plurality of powder particles; and
selecting a magnitude and a direction of levitation force generated by the at least one hardware device to achieve the computed thickness.
